(19) United States
(12) Patent Application Publication
(10) Pub. No.: US 2008/0096555 A1
(43) Pub. Date: Apr. 24, 2008

(54) Registration of a Mobiel Station in a Communication Network

(75) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,569

(22) PCT Filed: Sep. 23, 2005
(86) PCT No.: PCT/IB05/53158

§ 371 Date: Mar. 20, 2007

(30) Foreign Application Priority Data
Sep. 25, 2004 (GB) 0421408.6

(51) Int. Cl. H04Q 7/38

(52) U.S. Cl. 455/435.1

(57) ABSTRACT

Initial registration of a registration support system in a communication network requires complex signaling procedures, if the MSISDN remains unchanged for all mobile phones. According to an exemplary embodiment of the present invention an improved registration of a mobile station with PABX functionality in a communication network may be provided, wherein a group of users are enabled to share a common international mobile subscriber identity and mobile station ISDN number at different MSISDN extension numbers which are stored on the individuals SIM cards. Thus, core-network-internal signaling procedures may be considerably simplified.

The present invention relates to registration of a mobile station or mobile phone in a communication network. More particularly, the present invention relates to a registration support system for initial registration of a first mobile station in a communication network, to a mobile station for initial registration in a communication network, to a method of initial registration of a mobile station in a communication network and to a software program product for performing an initial registration of a mobile station in a communication network.

The international mobile subscriber identity (IMSI) is the very identity that defines a contract with a mobile phone network operator. Usually, the counterpart of this contract is an individual. The IMSI, together with security related information as well as for example, phone book entries, is stored on the subscriber identity module (SIM), which can be inserted in any mobile phone and then allows for setting up connections via a mobile phone network provided by the operator with whom the contract has been established.

Associated with the IMSI is a mobile station ISDN number (MSISDN), via which a mobile phone, which contains the SIM carrying a particular IMSI, can be reached from other mobile phones or via the fixed network.

In the current numbering schemes of GSM (Global System for Mobile Communication) or UMTS (Universal Mobile Telecommunication System), it is the IMSI which is used to identify a subscriber/contract within the core network (CN) and in some cases also within the radio access network (RAN). Therefore, on a large scale it is not possible to issue several SIM cards carrying the same IMSI, since both CN and RAN will be confused, when two phones with the same IMSI register in the RAN and CN.

Though these technical details disallow issuing several SIMs carrying the IMSI, there are scenarios in which it may be advantageous to do so. The problem of identification of a PABX (Private Automatic Branch Exchange) end point towards the RAN and the core network can be overcome by means of combining the IMSI stored on the SIM with the unique international mobile equipment identity (IMEI) stored in each mobile phone, as described in U.S. Pat. No. 5,765,105 “Communication System capable of using a plurality of subscriber identity media sharing a single subscriber identity information”, which is hereby incorporated by reference. Complex procedures are needed, by which call routing is done, if several mobile phones with a SIM having the same IMSI are registered with the radio access network and core network and one of them is called.

It is an object of the present invention to provide for an improved registration of a mobile station in a communication network.

According to an exemplary embodiment of the present invention as set forth in claim 1, the above object may be solved by a registration support system for initial registration of a first mobile station in a communication network, the registration support system comprising the first mobile station with a first data storage means and a second mobile station with a second data storage means, wherein the first data storage means is adapted for storing first information comprising a subscriber identity information and a first identifier, wherein the second data storage means is adapted for storing second information comprising the subscriber identity information and a second identifier. The subscriber identity information corresponds to a group of data storage means comprising the first data storage means and the second data storage means. Furthermore, the first identifier is different from the second identifier.

In other words, according to this exemplary embodiment of the present invention, the registration support system may comprise a plurality of mobile stations or receiving stations each containing data storage means all storing the same IMSI and therefore the same MSISDN but different identifiers.

Such an identifier may be, for example, an MSISDN extension number in the sense of PABX functionality, i.e. which is used together with the MSISDN for individual end point identification by the user during the calling procedure.

The identifier may also be mapped to an MSISDN extension number by means of a mapping table, which uniquely maps identifiers to MSISDN extension numbers.

The identifier may also correspond to an MSISDN extension number and a unique pointer to the MSISDN extension number, i.e. the identifier is then a pair composed of MSISDN extension number and the unique pointer to the MSISDN extension number.

Advantageously, a mobile operator may issue a set of SIMs carrying the same IMSI which may be used to set up a PABX-like connectivity environment for his customer, for example, a small to medium enterprise. Each employee gets a SIM to be used with his mobile phone, and all these SIMs store the same IMSI, but different MSISDN extension numbers, or different identifiers mapped to different MSISDN extension numbers.

According to another exemplary embodiment of the present invention as set forth in claim 2, the first mobile station is adapted for transmitting the first identifier together with the subscriber identity information, wherein the subscriber identity information corresponds to a group of data storage means comprising the first data storage means and the second data storage means and wherein the first identifier corresponds to the first data storage means.

The mobile station may transmit the first identifier together with the subscriber identity information to the communication network, when the mobile station books into the communication network so that it can use the network for communicating with other terminal equipment.

If the identifier and the MSISDN extension number are not identical, it may also be the identifier and not the MSISDN extension number, which is transmitted together with the subscriber identity information to the communication network.

According to another exemplary embodiment of the present invention as set forth in claim 3, the first mobile station is adapted for transmitting the first identifier together with the subscriber identity information and a first equipment identity information to the communication network, wherein the first equipment identity information corresponds to the first mobile station and wherein the first identifier corresponds to the first data storage means.

The mobile station may transmit the first identifier together with the subscriber identity information and the equipment identity information to the communication network, when the mobile station books into the communication network so that it can use the network for communicating with other terminal equipment. It should be noted, that it is not only the subscriber identity information, which is conveyed to the communication network, when the mobile phone books into the network, or in different terms “registers with the network”. In so far, this exemplary embodiment may supplement this registration procedure by the identifier and the equipment identity information. If the identifier and the MSISDN extension number are not identical, it may also be the identifier and not the MSISDN extension number, which is transmitted together with the subscriber identity information and the equipment identity information to the communication network, when the mobile station books into the communication network so that it can use the network for communicating with other terminal equipment.

Advantageously, this may further simplify signaling, e.g. in the sense that the network does not have to inquire the IMEI of the mobile phone. It may also simplify core network internal signaling in the sense that no additional message field for conveying the identifier between core network nodes may have to be added so that standardization effort is minimized.

Advantageously, according to this exemplary embodiment of the present invention, the operator may already store the identifier on the respective data storage means without knowing the mobile phones in advance. If the identifier and the MSISDN extension number are not identical, both the identifier and the MSISDN extension number may be stored by the operator on the respective data storage means.

According to another exemplary embodiment of the present invention as set forth in claim 4, the first data storage means comprises a first subscriber identity module, wherein the first subscriber identity module is adapted for storing the first information.

Advantageously, according to this exemplary embodiment of the present invention, the subscriber identity module may be configured by the network operator by storing on it the IMSI (which may correspond to a mobile station international ISDN number) and an individual identifier. If the identifier and the MSISDN extension number are not identical, both the identifier and the MSISDN extension number associated with it may be stored on the subscriber identity module. Alternatively, the operator may issue identical subscriber identity modules, each comprising the IMSI and MSISDN number, but no individual identifier (which may be stored later on the subscriber identity module triggered by the respective mobile station). If the identifier and the MSISDN extension number are not identical, they both may be stored later on the subscriber identity module.

According to another exemplary embodiment of the present invention as set forth in claim 5, the registration support system is adapted for triggering a generation of the first identifier on the basis of a generation protocol when the first mobile station books into the network with a SIM inserted, which is involved in such a registration procedure for the first time wherein, after generation of the first identifier, the first identifier is stored on the first data storage means.

If the identifier and the MSISDN extension number are not identical, the user may only see the MSISDN extension number to choose, by which then also the corresponding identifier may be chosen.

According to this exemplary embodiment of the present invention, the communication network may (after triggering by the registration support system) create individual identifiers, and convey them to the mobile stations which each have a SIM inserted (and which SIM is involved for the first time in a registration procedure), in the case where a new subscriber identity module is issued by the operator. Thus, all subscriber identity modules issued by the operator (to the respective group of users) may be identical. If the identifier and the MSISDN extension number are not identical, the communication network may create an identifier and an associated MSISDN extension number and convey them both to the mobile station, which involves a SIM for the first time in a registration procedure.

According to another exemplary embodiment of the present invention as set forth in claim 6, the registration support system further comprises selection means, wherein the selection means is adapted for selecting the first identifier by a user. After selection of the first identifier, the first identifier is stored on the first data storage means. If the identifier and the MSISDN extension number are not identical, the selection means may be adapted for selecting the MSISDN extension number, by which then also the corresponding identifier may be selected.

Advantageously, according to this exemplary embodiment of the present invention, the user may select (at a certain time, e.g. when the assignment is to be done, which is usually the case, when the user's mobile station books into the network with the SIM used for the first time), which identifier of a plurality of generated possible identifiers (i.e. not yet assigned to another SIM of the respective group of SIMs) is to be used as the individual identifier associated with this SIM. If the identifier and the MSISDN extension number are not identical, the user may only see the MSISDN extension number to select, by which then also the corresponding identifier may be selected.

According to another exemplary embodiment of the present invention as set forth in claim 7, the first mobile station comprises a first equipment identity information corresponding to the first mobile station, wherein the registration support system is adapted for storing the first equipment identity information on the first data storage means.

Advantageously, by storing the first equipment identity information on the first storage means, registration of the first mobile station in the communication network may be further improved.

According to another exemplary embodiment of the present invention as set forth in claim 8, the registration support system is set up for storing an assignment between the subscriber identity information and the first identifier in a register of the communication network. If the identifier and the MSISDN extension number are not identical, the stored assignment is between the subscriber identity information, the first identifier and the MSISDN extension number.

Advantageously, this may allow for addressing the first mobile station by another mobile station via the network after the assignment has been stored in the register of the communication network.

According to another exemplary embodiment of the present invention as set forth in claim 9, the registration support system is set up for storing an assignment between the subscriber identity information, the equipment identity information and the first identifier in a register of the communication network. If the identifier and the MSISDN extension number are not identical, the stored assignment is between the subscriber identity information, the equipment identity information, the first identifier and the MSISDN extension number.

According to another exemplary embodiment of the present invention as set forth in claim 10, the registration support system is adapted for performing manual removal of the first equipment identity information from the first data storage means.

According to another exemplary embodiment of the present invention as set forth in claim 11, a mobile station for initial registration in a communication network is provided, the mobile station comprising a first data storage means, wherein the first data storage means is adapted for storing first information comprising a subscriber identity information and a first identifier and wherein the first identifier is different from a second identifier stored together with the subscriber identity information by a second data storage means of a second mobile station. If the identifier and the MSISDN extension number are not identical, the first data storage means may be adapted for storing first information comprising a subscriber identity information, a first identifier, and a first MSISDN extension number, wherein the first identifier (and the first MSISDN extension number) is different from a second identifier (and second MSISDN extension number) stored together with the subscriber identity information by a second data storage means of a second mobile station.

Advantageously, this exemplary embodiment of the present invention may provide for a mobile station which is adapted to perform an improved registration in a communication network.

According to another exemplary embodiment of the present invention as set forth in claim 12, a method of initial registration of a mobile station in a communication network is provided wherein the mobile station comprises a first data storage means and the method comprises the step of transmitting a first identifier and a subscriber identity information, both stored on the first data storage means, from the mobile station to the communication network. The subscriber identity information corresponds to a group of data storage means comprising the first data storage means, and the first identifier corresponds to the first data, storage means. If the identifier and the MSISDN extension number are not identical, both the identifier, and the MSISDN extension number associated with the identifier correspond to the first data storage means.

In other words, according to this exemplary embodiment of the present invention, a method for initial registration of a mobile station in a communication network is provided, wherein the mobile station carries a subscriber identity information which is identical to the subscriber identity information of other mobile stations within a group of mobile stations. Furthermore, the mobile station carries, for example, the same mobile station international ISDN number (which may correspond to the subscriber identity information) as the other mobile stations of the group of mobile stations, but an individual first identifier (which is different from the identifiers of the other mobile stations of the group of mobile stations). If the identifier and the MSISDN extension number are not identical, the mobile station carries the same mobile station international ISDN number as the other mobile stations of the group of mobile stations, but an individual first identifier and an individual first MSISDN extension number, which is different from the identifiers and MSISDN extension numbers of the other mobile stations of the group of mobile stations. This may provide for an improved registration of the first mobile station in the communication network.

Other exemplary embodiments of the present invention are set forth in the sub-claims 13 to 17.

According to another exemplary embodiment of the present invention as set forth in claim 18, a computer program for performing an initial registration of a mobile station in a communication network is provided, wherein the computer program causes a processor to perform a method according to the present invention.

It may be seen as the gist of an exemplary embodiment of the present invention that PABX functionality is provided to a communication network which is, for example, running in a GSM or UMTS mode, based on a single contract represented by a number of identical SIM cards which comprise the same IMSI (and thus the same MSISDN number). For individual user registration corresponding identifiers (which may be identical to MSISDN extension numbers or may each be uniquely mapped to MSISDN extension numbers) are introduced and, according to an exemplary embodiment of the present invention, each stored on the corresponding individual SIM card. Thus, core-network-internal signaling procedures may be considerably simplified.

These and other aspects of the present invention will become apparent from and elucidated with reference to the embodiment described hereinafter.

Exemplary embodiments of the present invention will be described in the following, with reference to the following drawings:

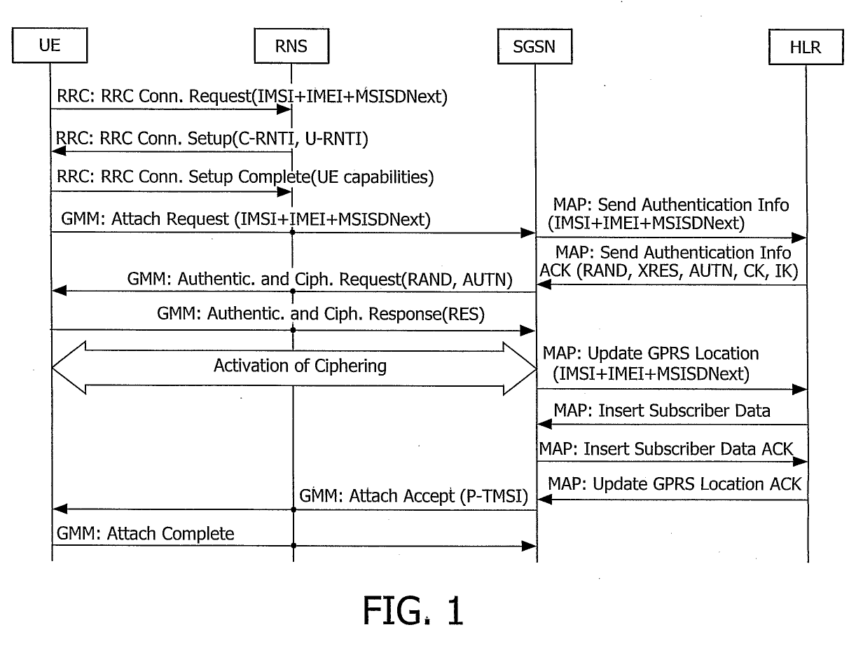

FIG. 1 shows a schematic representation of an initial registration of a mobile station in a packet-switched domain involving a SIM of a group of SIMs with identical IMSI and MSISDN, where the SIM already stores an identifier, which identifier is identical to an MSISDN extension number and may already be stored together with the IMSI and the MSISDN in the home location register (HLR) before delivery of the SIMs;

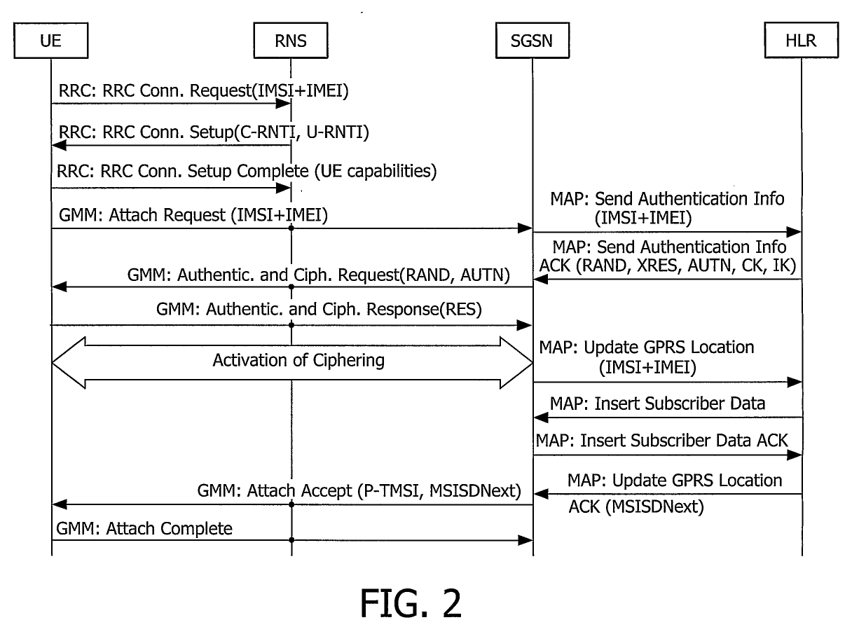

FIG. 2 shows a schematic representation of an initial registration of a user equipment in a packet-switched domain involving a SIM of a group of SIMs with identical IMSI and MSISDN, where the SIM does not yet store an identifier, which identifier is identical to an MSISDN extension number, and may already be available in the HLR together with the IMSI and MSISDN or may be generated in the HLR, which until the generation may only store the IMSI and the MSISDN, and which identifier is conveyed to the SIM via the user equipment in the course of the registration procedure;

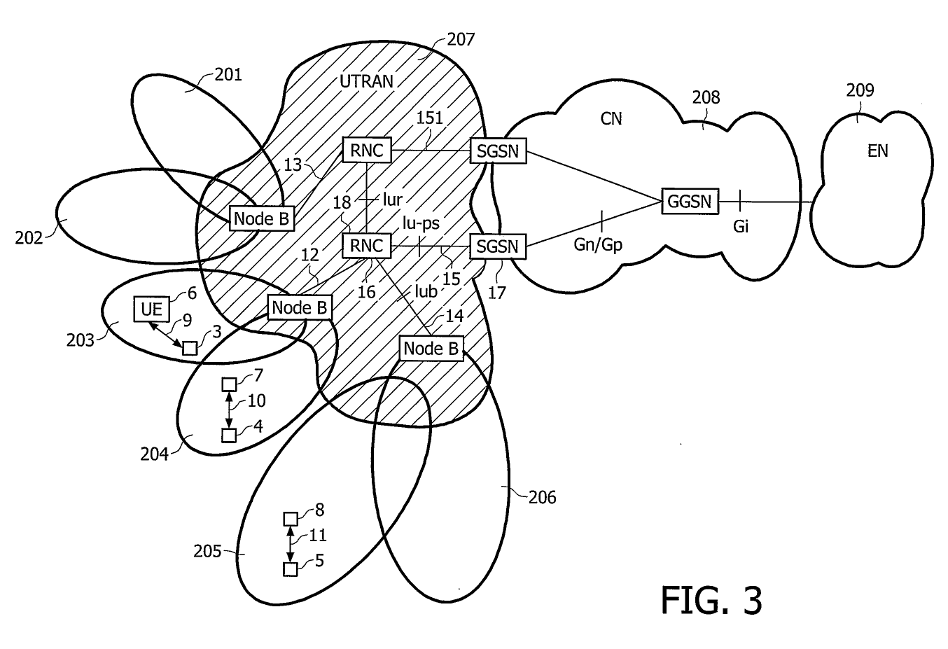

FIG. 3 shows a registration support system according to an exemplary embodiment of the present invention.

FIG. 1 shows a schematical representation of an initial registration of a mobile station in a packet-switched domain, where the MSISDN extension number is already assigned to the HLR before the SIMs are delivered. As may be seen from FIG. 1, the present invention describes a concept and the necessary signaling procedures which may allow for avoiding complex procedures in such a way that for a calling party the called party is selected in the same way as it is done in the case of a PABX, i.e. by means of a base number which is supplemented by an extension number.

Hence, a mobile operator may issue a set of SIM cards carrying the same IMSI, which may be used to set up PABX-like connectivity environment for his customer, which may be, for example, a small to medium enterprise.

Each employee gets a SIM containing the same IMSI and uses it together with his mobile phone. Therefore, the MSISDN available in case of the unique SIM is used and supplemented with extension numbers, one for each mobile phone of each employee.

Each mobile phone (also called user equipment (UE) or mobile station) of the PABX-pool has its own SIM, which communicates with the mobile phone, for example, via the wired SIM-UE interface. In principle, the MSISDN extension number may be defined by two different procedures, namely defined by the operator or service provider of the network, who issues the SIM cards with an MSISDN extension number stored on the SIM, or it may be generated by the communication network (wherein the generation may be triggered by the registration support system), when the SIM (without an MSISDN extension number stored on it) is for the very first time involved in a user equipment booking into the network, which user equipment has this SIM inserted.

In any case, during the process of defining a new MSISDN extension number, an extension to the location registers (in HLR (Home Location Register), VLR (Visitor Location Register) and SGSN (Serving GPRS Support Node)) has to be provided, since in addition to the IMSI and the MSISDN, the MSISDN extension number and if applicable the IMEI have to be stored, and the location registers have to be made aware of the fact that the IMSI of the particular contract is used with multiple mobile phones having a different MSISDN extension number. If also the IMEI is stored, this may provide for further simplification of procedures.

Since SIM cards are issued by the operators for the purpose of setting up a PABX-pool, the operator may already store an MSISDN extension number on the SIM in addition to the MSISDN and the IMSI. The set of SIMs used to set up a PABX-pool, i.e. SIMs, which are issued with the same IMSI and for the purpose addressing mobile phones by an MSISDN plus an MSISDN extension number, is also called here a SIM pool.

When the SIM is used for the first time with a mobile phone, during the registration procedure, the mobile phone, according to an exemplary embodiment of the present invention, may send the IMSI and MSISDN extension number (and if applicable its IMEI), via the radio access network, to the core network. According to an aspect of the present invention, IMSI and the MSISDN extension number and if applicable the IMEI of the mobile phone are stored on the SIM hosted by the mobile phone. The MSISDN may already be known to the core network and the core network may then store, at least in the home location register (HLR), the assignment between IMSI, MSISDN extension number and (if applicable) the IMEI.

If one of the employees inserts his SIM into a different mobile phone (potentially even one of his colleagues, i.e. a mobile phone, which previously hosted another SIM with the same IMSI and a different MSISDN extension number), the association between IMSI, MSISDN extension number and IMEI may be changed such that IMEI of the user equipment, that currently holds the SIM card, is known in conjunction with the MSISDN extension number in the core network (i.e. at least the HLR) and, for example, also in the radio access network, when the user equipment registers in the core network and the radio access network. For CN and RAN internal-routing, known techniques for “location registration” or “GPRS attach” may be applied where the corresponding messages only have to be augmented by an MSISDN extension number field or if applicable by at least one of an MSISDN extension number field and an IMEI field, since the IMSI of the contract is already known to the HLR.

TMSI (Temporary Mobile Subscriber Identity) and LAI (Location Area Identity) or P-TMSI (TMSI of the packet switched domain) and RAI (Routing Area Identity) (the latter in the case when a mobile phone is connected to the packets switched domain, the former in the case, when the mobile phone is connected to the circuit-switched domain) combination may be assigned to the mobile phone as a temporary core network related identifier, which may be used in all cases, where it is not necessary to identify the mobile phone via the IMSI and IMEI combination. This TMSI and LAI combination may have to be stored together with the IMEI on the SIM so that when inserting the SIM into another user equipment, consequently with a different IMEI (“IMEI new”), the user equipment identifies itself by means of the IMSI and “IMEI new” and MSISDN extension number combination to the core network. Then, a new TMSI and LAI may be assigned for this new end point, i.e. a mobile phone with “IMEI new” containing a SIM, which carries IMSI and the MSISDN extension number, and the previous TMSI and LAI combination is discarded.

As may be seen from FIG. 1, the registration procedure according to an exemplary embodiment of the present invention in the case of a packet-switched domain of a UMTS network may be performed by the following steps (it should be noted that a similar scheme holds for the circuit-switched domain):

For setting up the Radio Resource Control (RRC) connection between the user equipment and the radio network system (RNS), where the “RRC connection request” message is provided such that it also carries the IMSI, the MSISDN extension number, which is denoted by MSISDNext in FIG. 1, and if applicable the IMEI of the mobile phone hosting the SIM card. The addition of the IMEI may provide for further simplification.

In UMTS, the RNS is represented by an RNC (Radio Network Controller with all the NodeBs, which the RNC controls).

Similarly, the “attach request” message, which may be sent from the user equipment to the serving GPRS support mode (SGSN), as well as the “send authentication info” message, which may be sent from the SGSN to the HRL, are provided in such a way, that they carry the IMSI, the MSISDN extension number, and if applicable the IMEI. With the “send authentication info” message the linkage between the IMSI, the MSISDN extension number and if applicable the IMEI is made available to the HLR so that for core network internal addressing purposes the end point is uniquely identified by the IMSI, the MSISDNext and if applicable the IMEI, while for call routing purposes the MSISDN and MSISDN extension number may now be visible to the core network by virtue of the linkage between the MSISDN extension number, the IMSI and if applicable the IMEI.

With the “send authentication info ACK” such a particular Quintuple (RAND, XRES, AUTN, CK and IK) is delivered to the SGSN for the particular end point (identified by IMSI, MSISDN extension number and if applicable IMEI), and the SGSN then initiates the authentication procedure towards the user equipment. Since an RRC connection already exists, addressing of the end point, which is the user equipment identified by the MSISDN extension number in conjunction with the IMSI of the SIM hosted by the user equipment, and if applicable the IMEI of the user equipment, may be performed by means of the UTRAN radio network temporary identity (U-RNTI), which is unique throughout the UTRAN.

Since under the same IMSI a bigger number of end points may be reached, the HLR may have to retrieve many more security Quintuples from the Authentication Center (not shown in FIG. 1).

In the circuit-switched domain, the relevant core network node, which connects the RNC to the core network (and thus corresponds to the SGSN), is the MSC (Mobile Switching Center). The available messages to convey registration information may have different names. Also, the VLR (Visitor Location Register) may be involved explicitly in the circuit-switched domain, while it may be functionality of the SGSN in the packet-switched domain.

FIG. 2 shows a schematic representation of an initial registration of a user equipment in a packet-switched domain, where an MSISDN extension number is not yet assigned to the HLR. This type of initial registration may only be performed exactly once, when a SIM of the SIM pool is used for the very first time in a mobile phone, so that the SIM does not yet store an MSISDN extension number. After this procedure, an MSISDN extension number is stored on the SIM, and for subsequent registration procedures of a mobile phone hosting this SIM, the initial registration procedure according to FIG. 1 applies. According to FIG. 2, the MSISDN extension number may also be generated within the core network (e.g. on the HLR) when a SIM has no MSISDN extension number stored and is used for the first time in a user equipment to book into the network. The extension number then may just be given by N1±1, where N1 is the number of SIMs of the SIM pool, which SIMs were already involved in a registration procedure of mobile phones hosting these SIMs, so that an MSISDN extension number was already stored on each of these SIMs. It is to be noted here that the IMEI of each mobile phone is unique world-wide.

Hence, for the SIMs of the pool of SIMs SIM_pool={S1, S2, S3, . . . }, which share the same IMSI, the following holds:
the SIM S1, which is used with a mobile phone to perform the very first initial registration that involves a SIM of SIM_pool, gets the extension number “1”, and this extension number is then no longer available,
the SIM S2, which is used with a mobile phone to perform the very first initial registration that involves a SIM of SIM_pool without S1 (i.e. of SIM_pool\{S1}), gets the extension number “2”, and this extension number is then no longer available,
the SIM S3, which is used with a mobile phone to perform the very first initial registration that involves a SIM of SIM_pool without S1 and S2 (i.e. of SIM_pool\{S1, S2}), gets the extension number “3”, and this extension number is then no longer available,
   and so on.

Of course, there may be other ways to assign an extension number during the very first initial registration without departing from the scope of the present invention. For example, during the very first registration involving a particular SIM, the core network may convey a list of available extension numbers, and this list is indicated to the user via the display of his mobile phone hosting the SIM. The user can then choose one extension number from the list.

After an extension number has been assigned, the extension number stored on the SIM may be displayed on a mobile phone screen (for example triggered by the user), as it is already possible for the MSISDN on current mobile phones.

This may simplify the required procedures for the network operator, since he only may have to indicate to the HLR that under a given IMSI several end points can be reached, which are differentiated by the MSISDN extension number or if applicable by the IMEI of the mobile phone and addressable via an MSISDN plus the MSISDN extension number.

After this very first registration of the mobile phone, the MSISDN extension number is stored on the SIM. In addition, if applicable the IMEI may also be stored on the SIM, according to FIG. 1, together with the new TMSI and LAI or P-TMSI and RAI so that this particular SIM may also be used with other mobile phones which always have a different IMEI. In this case the old IMEI may be removed from the SIM possibly together with the TMSI and LAI or P-TMSI and RAI which may be newly assigned by the network within a further registration procedure, in which the mobile phone identifies itself to the core network by means of the IMSI, the MSISDN extension number and if applicable the new IMEI.

This may be necessary for the following reason: Assume that the SIM with an MSISDN extension number has stored a combination of TMSI and LAI when being used with UE1 with IMEI(UE1). If it is later inserted in UE2, and the TMSI+LAI combination assigned so far is kept, the core network assumes that under the TMSI+LAI combination an endpoint is addressed, which has IMEI(UE1). In the rare but possible case that the core network cannot contact the endpoint with the TMSI+LAI combination and therefore may decide to use the IMSI+IMEI combination associated with the TMSI+LAI combination, it will be impossible to reach UE2, which now hosts the SIM and therefore is the new endpoint, since UE2 has a different IMEI(UE2). This problem may only be resolved, if UE2—after the SIM with IMEI(UE1) stored on it is inserted into UE2 and UE2 is switched on—starts a registration procedure towards the network, in which it identifies itself (i.e. the new endpoint) with the IMSI, the IMEI of UE2 and the MSISDN extension number, removes the stored IMEI(UE1) and stores IMEI(UE2) on the SIM.

Yet another approach to solve the above problem is as follows: If UE 2 in the above example, after the SIM has been removed from UE1 and has been inserted into UE2 registers with the network for the first time, it still uses the TMSI+LAI combination stored on the SIM to register with the network. In reply to the registration attempt using the TMSI+LAI combination, the network (knowing that the UE represents an end-point, which is identified by means of an IMSI and an extension number) will then supplement the registration procedure by an inquiry procedure, in which UE2 is asked to indicate its own IMEI (and possibly the IMSI and the MSISDN extension number stored on the SIM). After completion of this procedure, the network is aware of the correct association between TMSI+LAI and IMEI(UE2), IMSI, and MSISDN extension number.

According to FIG. 2, the MSISDN extension (“MSISDNext”) is assigned in the course of the very first registration procedure. In all subsequent registration procedures, the MSISDN extension number may no longer be delivered from the network to the SIM hosted in the mobile phone or UE, since it has already been stored on the SIM.

FIG. 3 shows a registration support system according to an exemplary embodiment of the present invention in the case of the PS (packet-switched)-domain of UMTS. The network depicted in FIG. 3 comprises a plurality of radio cells 201, 202, 203, 204, 205, 206, comprising the UEs or mobile stations 6, 7, 8, and different network nodes, such as different NodeBs (which link the UTRAN 207 to the radio cells), RNCs, SGSNs (Serving GPRS Support Node) and GGSN (Gateway GPRS Support Node) nodes. NodeB and RNC, which are part of the UTRAN, are linked via the lu-ps interface. RNC and SGSN (which links the UTRAN to the CN 208) are linked via the lu-ps interface. SGSN and GGSN, which is part of the CN 208, are linked via the Gn/Gp interface. Furthermore, the GGSN is linked to an external network 209 via the Gi interface, which may be the well-known Internet.

The registration support system comprises a first mobile station 6, a second mobile station 7 and a third mobile station 8. Furthermore, the registration support system comprises a first processor 3, a second processor 4 and a third processor 5 which are linked to the first, second and third mobile stations 6, 7, 8 via communication links 9, 10, 11, respectively.

The processors 3, 4, 5 are used for executing a computer program for performing an initial registration of a mobile station in the communication network. Hereby, for example, the computer program causes processor 3 to perform a transmission of a first extension number stored on a first data storage means together with a subscriber identity information and if applicable an equipment identity information from the first mobile station 6 to the communication network. The first data storage means (which is not shown in FIG. 3) may be part of the first mobile station 6, or may for example be an IC card as used to implement the SIM card for mobile phones of today. Furthermore, processor 3 may be integrated in the first mobile station 6, processor 4 may be integrated in the second mobile station 7 and processor 5 may be integrated in the third mobile station 8.

The equipment identity information, which if applicable is transmitted from the first mobile station 6 to the RNC 16 is transmitted via communication link 12 and is the individual equipment identity information of the first mobile station 6. Together with the individual first extension number of the data storage means used with first mobile station 6, the subscriber identity information (which is the same for the data storage means of all three mobile stations 6, 7, 8), and if applicable the individual first equipment identity information is transmitted via communication link 12.

The same or other information may be transmitted from the first mobile station 6 to a second register 17, which, for example, may be a Visitor Location Register (VLR) hosted by the SGSN, via communication link 15. The same or other information may also be transmitted further into the core network to the Home Location Register (HLR), which is not shown in FIG. 3.

It should be noted in this context, that FIG. 3 is a very schematic and simplified representation of such a registration support system and the corresponding signaling links used for initial registration of a mobile station in a communication network. More detailed representations are provided in FIGS. 1 and 2.

However, after the first mobile station 6 has been assigned an MSISDN extension number, the second mobile station 7 may book into the network. According to an aspect of the present invention, the second mobile station 7 comprises a second subscriber identity module (SIM) which (initially) stores the same subscriber identity information as the SIM card of mobile station 6 together with an MSISDN telephone number. When the second mobile station 7 books into the network involving the SIM for the first time in a registration procedure, a generation of a set of possible extension numbers is performed in the network, e.g. in the HLR on the basis of a generation protocol. After generation of the set of possible MSISDN extension numbers, this set is conveyed to the mobile station e.g. via the communication links 15 and 12, and the user of the second mobile station 7 is asked to select one MSISDN extension number of the set of possible MSISDN extension numbers by means of a selection tool. After selecting an individual MSISDN extension number, this particular MSISDN extension number is stored on the second SIM card of the second mobile station 7, and the e.g. the HLR is informed about the user's choice so that it can build up the association between the IMEI of mobile station 7, the IMSI of the SIM inserted in mobile station 7 and the MSISDN extension number.

The IMSI of the SIMs of the pool of SIMs may be used by the network to address all mobile phones, which are booked into the network with a SIM of this pool together e.g. for maintenance purposes.

Signaling between the second mobile station of the registration support system and other parts of the communication network may be performed via at least one of the communication links 12, 13, 14, 15, 151 and an additional communication link to the HLR, which communication link and HLR both are not shown in FIG. 3.

Furthermore, after the first MSISDN extension number has been assigned to the first mobile station 6 and the second MSISDN extension number has been assigned to the second mobile station 7, a third user may book into the network for the first time by putting a new SIM card into his mobile station 8 and switching on the mobile station 8. Then, a further generation or selection of a set of possible MSISDN extension numbers is triggered and executed by the core network (e.g. by the HLR), which conveys the list of possible MSISDN extension numbers via communication links 15 and 14 and via the air interface to mobile station 8. After that, a selection of an appropriate MSISDN extension number may be performed by the user of mobile station 8, and this individual MSISDN extension number is then stored in the SIM card of mobile station 8 and transmitted together with the subscriber identity information and if applicable with the equipment identity information of the third mobile station 8 to relevant core network nodes and radio access network nodes via an RNC as already shown with the relevant messages in FIG. 1.

The invention may be applied for small to medium enterprises, where the employees spend most of their time out of the office, so that internal telephone communication between offices in the same building will not account for most of the communication since “air time” with a mobile apparatus is usually quite expensive. In a different business model, an operator may provide telephone communication links in an office area for free, while charges would apply outside the office area. Such a business model may require an evaluation of location information in order to distinguish between calls within the office area and calls with at least one termination outside the office.

A single contract may be operated for all members of a group (similar to a PABX). For this purpose, the operator may issue SIM cards with the same IMSI and a different extension number each or even identical copies of the same SIM card (of the new type according to an exemplary embodiment of the present invention) each carrying the same IMSI but no MSISDN extension number.

Thus, the operator may first issue a single SIM of the new type where the MSISDN extension number is not used or is not present and later on issue additional SIM cards (with the same IMSI and an additional extension numbers or no extension numbers), if PABX functionality is desired for later on.

Therefore, the number of IMSIs which have to be delivered to the group of users is reduced to only one and the number of available telephone numbers is increased, since in addition to the MSISDN, MSISDN extension numbers are used, which can be separated from the MSISDN numbering scheme.

It should be noted that the term “comprising” does not exclude other elements or steps and the “are” “or” “an” does not exclude a plurality and that a single processor or system may fulfill the functions of several means recited in the claims. Also elements described in association with different embodiments may be combined.

It should also be noted that any reference signs in the claims shall not be construed as limiting the scope of the claims.

1. A registration support system for initial registration of a first mobile station in a communication network, the registration support system comprising:
the first mobile station with a first data storage means;
a second mobile station with a second data storage means;
wherein the first data storage means is adapted for storing first information comprising a subscriber identity information and a first identifier;
wherein the second data storage means is adapted for storing second information comprising the subscriber identity information and a second identifier; and
wherein the first identifier is different from the second identifier.

2. The registration support system of claim 1,
wherein the first mobile station is adapted for transmitting the first identifier together with the subscriber identity information;
wherein the subscriber identity information corresponds to a group of data storage means comprising the first data storage means and the second data storage means; and
wherein the first identifier corresponds to the first data storage means.

3. The registration support system of claim 2,
wherein the first mobile station is adapted for transmitting the first identifier together with the subscriber identity information and a first equipment identity information to the communication network; and
wherein the first equipment identity information corresponds to the first mobile station.

4. The registration support system of claim 1,
wherein the first data storage means comprises a first subscriber identity module; and
wherein the first subscriber identity module is adapted for storing the first information.

5. The registration support system of claim 1,
wherein the registration support system is adapted for triggering a generation of the first identifier on the basis of a generation protocol when the first mobile station books in the network for the first time; and
wherein, after generation of the first identifier, the first identifier is stored on the first data storage means.

6. The registration support system of claim 5, further comprising selection means;
wherein the selection means is adapted for selection of the first identifier by a user; and
wherein, after selection of the first identifier, the first identifier is stored on the first data storage means.

7. The registration support system of claim 1,
wherein the first mobile station comprises a first equipment identity information corresponding to the first mobile station; and
wherein the registration support system is adapted for storing the first equipment identity information on the first data storage means.

8. The registration support system of claim 1,
wherein the registration support system is adapted for storing an assignment between the subscriber identity information and the first identifier in a register of the communication network.

9. The registration support system of claim 1,
wherein the registration support system is adapted for storing an assignment between the subscriber identity information, the equipment identity information and the first identifier in a register of the communication network.

10. The registration support system of claim 1,
wherein the registration support system is adapted for performing a manual removal of the first equipment identity information from the first data storage means.

11. A mobile station for initial registration in a communication network, the mobile station comprising a first data storage means;
wherein the first data storage means is adapted for storing first information comprising a subscriber identity information and a first identifier; and
wherein the first identifier is different from a second identifier stored together with the subscriber identity information by a second data storage means of a second mobile station.

12. A method of initial registration of a mobile station in a communication network,
wherein the mobile station comprises a first data storage means;
the method comprising the step of:
transmitting a first identifier and a subscriber identity information, both stored on the first data storage means, from the mobile station to the communication network;
wherein the subscriber identity information corresponds to a group of data storage means comprising the first data storage means; and
wherein the first identifier corresponds to the first data storage means.

13. The method of claim 12,
wherein an equipment identity information is transmitted together with the first identifier and the subscriber identity information;
wherein the equipment identity information corresponds to the mobile station;
wherein the first identifier is stored on the first data storage means by the following steps:
generating the first identifier by the registration support system on the basis of a generation protocol when the first mobile station books in the network for the first time; and
storing the first identifier on the first data storage means after generation of the first identifier.

14. The method of claim 12, further comprising the step of:
selecting the first identifier by a user;
wherein, after selection of the first identifier, the first identifier is stored on the first data storage means.

15. The method of claim 12, further comprising the step of:
storing an assignment between the subscriber identity information and the first identifier in a register of the communication network.

16. The method of claim 13, further comprising the step of:
storing an assignment between the subscriber identity information, the equipment identity information and the first identifier in a register of the communication network.

17. The method of claim 12, wherein the method is applied for data transmission in UMTS.

18. A computer program for performing an initial registration of a mobile station in a communication network, wherein the computer program causes a processor to perform the following operation when the computer program is executed on the processor:
transmitting a first identifier stored on a first data storage means together with a subscriber identity information and an equipment identity information from the mobile station to the communication network;
wherein the mobile station comprises the first data storage means;
wherein the equipment identity information corresponds to the mobile station;
wherein the subscriber identity information corresponds to a group of data storage means comprising the first data storage means; and
wherein the first identifier corresponds to the first data storage means.
